(19) United States
(12) Patent Application Publication
(10) Pub. No.: US 2003/0128249 A1
(43) Pub. Date: Jul. 10, 2003

(54) Inkjet printer with nozzle maintenance system in printing media carrier

(76) Inventor: Andrew J. S. Booth, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/309,820

(22) Filed: Dec. 5, 2002

(30) Foreign Application Priority Data
Dec. 5, 2001 (CA) 2,364,396

(51) Int. Cl. B41J 2/165

(52) U.S. Cl. 347/22

(57) ABSTRACT

A maintenance system for an inkjet printhead is located within a printing media carrier of an inkjet printer. By locating the maintenance system within the range over which the inkjet printhead assembly normally moves during full width printing, the printing media carrier may be moved to place the maintenance system in a position proximate the inkjet printhead assembly to be maintained. The printing media carrier may also be moved to place the maintenance system in a position where it may itself be serviced by a docking station.

### TECHNICAL FIELD

The invention pertains to the field of inkjet printing and, in particular, to the maintenance of inkjet printheads.

### BACKGROUND

Drop-on-demand or continuous-stream inkjet printers, such as thermal, piezoelectric, acoustic, or phase change wax-based printers, have at least one printhead from which droplets of ink are directed towards a printing medium (or substrate). Within such printheads, ink is typically contained in a plurality of channels. By means of power pulses, droplets of ink are expelled as required from orifices or nozzles at the end of these channels. The mechanisms whereby ink ejection works in these various types of machines are well established and will not be further discussed herein.

An ink jet printhead may be incorporated into a carriage type printer, a partial width array type printer, or a pagewide type printer. A carriage type printer typically has a relatively small printhead containing a number of ink channels and nozzles. The printhead can be attached to a disposable ink supply cartridge and the combined printhead and cartridge assembly is attached to a carriage. The carriage is reciprocated to print one swath of information (having a height equal to the length of a column of nozzles) at a time on a recording medium, which is typically maintained in a stationary position during the reciprocation. After the swath is printed, the paper is stepped a distance equal to the height of the printed swath or a portion thereof, so that the next printed swath is contiguous or overlapping therewith. Overlapping is often employed to address a variety of undesirable inkjet printing artifacts that may be traced to nozzle performance. This procedure is repeated until the entire page is printed.

In contrast, a pagewide printer includes a substantially stationary printhead having a length sufficient to print across the width or length of a sheet of printing medium. The printing medium is continually moved relative to the pagewide printhead in a direction which may be substantially normal to the printhead length. In most cases, the separation between individual nozzles is greater than the required dot spacing on the media, and hence the media may be passed under the pagewide printhead more than once in order to print at the interstitial positions or to address a variety of undesirable inkjet printing artifacts that may be traced to nozzle performance.

There is a need to maintain the ink ejecting nozzles of an ink jet printhead. For example, the orifices typically need to be cleaned periodically and/or the printhead needs to be capped when the printer is out of use or is idle for an extended period. The capping of the printhead is aimed at preventing components of the ink in the printhead from evaporating and preventing contaminants from entering the printhead or contaminating the nozzle plate. There is sometimes a need to prime a printhead before use. This is done to insure that the printhead channels are completely filled with ink and contain no contaminants or air bubbles. Periodic priming may also be necessary to maintain proper functioning of the orifices. Maintenance and/or priming stations for the printheads of various types of ink jet printers are described for example, in U.S. Pat. Nos. 4,855,764, 4,853,717, and 4,746,938.

Various methods and apparatus for maintaining the condition of ink jet printheads are generally known in the art, as illustrated and described in the following references.

U.S. Pat. No. 5,206,666 to Watanabe et al., describes an ink jet recording apparatus having a full-line type recording head that is rotated between a recording position and a non-recording position. A cleaning member contacts the recording head during rotation of the recording head to remove deposited ink or foreign matter. In the non-recording position, the printhead is capped.

U.S. Pat. No. 5,257,044 to Carlotta et al., describes a cap actuation mechanism for an inkjet printhead maintenance station in a scanning type ink jet printer. A cap located on a cap carriage in the maintenance station provides the functions of printhead nozzle capping, priming, cleaning, and refreshing, as well as waste ink management.

U.S. Pat. No. 5,367,326 to Pond et al., describes a pagewide ink jet printer having a movable cleaning/priming station adapted for movement parallel to and along an array of printhead nozzles. The cleaning and priming station is slid along a ledge surface so that the cleaning and priming station is maintained a fixed distance from the face of the printhead.

A number of proposals suggest the use of media sheets for cleaning and maintaining inkjet printheads. For example, Japanese patent application JP 4141439A2 discloses a method for cleaning a printhead by pressing paper traveling through a printer against the printhead. Similarly, U.S. Pat. No. 4,947,190 suggests the use of an ink-absorbing cleaning sheet that is brought into contact with the printhead in order to wipe and clean the printhead. Other proposals for cleaning sheets have included sheets with specified surface roughnesses, adhesives, or absorbent or solvent-soaked pads (e.g., see U.S. Pat. No. 6,030,674, U.S. Pat. No. 5,589,865, U.S. Pat. No. 6,277,457, U.S. Pat. No. 5,751,306, U.S. Pat. No. 5,589,865).

Because media sheets work by coming into physical contact with the nozzle orifice plate, they can be made suitable for operations such as wiping off ink or debris or applying solvent. However, care must be taken to ensure that:

a) the contact with the orifice plate does not abrade or otherwise damage the surface;

b) the action of the media sheet, or debris from the sheet itself, does not contribute to the clogging of nozzle orifices; and,

c) the media sheet makes adequate contact with the surface to be cleaned.

Media sheets also offer the advantage they can be transported past the inkjet printhead along the existing media carrier path. However, it should be noted that rubbing and wiping printhead surfaces alone does not address all of the maintenance needs associated with inkjet printheads, so additional mechanisms for capping, priming, spitting, and/or suctioning the printheads will still be required for adequate maintenance. This requirement is reflected in U.S. Pat. No. 5,589,865, which discloses a cleaning sheet which has an opening in order to allow the passage of a separate vacuum wand.

As the technology has developed for fabricating ever higher resolution inkjet heads with ever greater densities of nozzles, and, more particularly, with the advent of pagewide systems, the requirements placed on maintenance systems have become even more complex. A typical maintenance assembly may include:

a) a cap assembly to seal around an individual printhead or nozzle plate to keep the particular inkjet nozzle array from drying out and the nozzle plate free from contaminants;

b) a wiper that can be moved to engage the nozzle surface of the printhead and clear away ink, debris and other undesirable matter from the surface of the nozzle plate area, and which may be moved away from the nozzle surface when wiping is not desired;

c) a spittoon for receiving ink ejected from the nozzles to remove contaminated ink from the nozzles and to maintain less used nozzles;

d) a selection of drive assemblies that may include a gear train for moving the cap, wiper and/or a spittoon;

e) an absorption pad for absorbing drops of ink ejected during maintenance so that the printer may be transported without damaging or soiling parts of the printer with purged ink; and,

f) a mechanism for cleaning the cap and wiper to prevent contaminants being transported onto the nozzle plate during successive maintenance procedures.

From these above it is clear that a typical inkjet printhead maintenance system can be a complex subsystem with many moving parts.

U.S. Pat. No. 6,179,403 to Xie describes a drum-based inkjet printing apparatus that includes a maintenance system located at one end of the print drum. The maintenance system includes assemblies that provide wet wiping of the nozzles of the printheads as well as vacuuming of the same printheads for maintenance thereof. The wet wipe nozzles are located within a stationary drum housing and extend through a plurality of apertures when necessary to provide maintenance functions. The printhead is mounted on a carriage which moves to the maintenance position, where the wet wipers apply a fluid to the ink jet nozzles such that any dried ink, viscous plugs or other debris is loosened on the front face of the ink jet printbars. Once the debris has been sufficiently loosened, a plurality of vacuum nozzles each extending through a plurality of vacuum nozzle apertures vacuum away any of the cleaning fluid as well as debris loosened thereby.

Other examples are known in the art, where a pad is attached to an extra-wide cylinder and the printhead is translated over a long distance to clear the nozzles over this pad.

While this approach addresses some of the requirements enumerated above, it nevertheless still requires the entire high precision printhead to be translated over a considerable distance to a service/maintenance position.

### SUMMARY OF INVNETION

A maintenance system for an inkjet printhead is located within the printing media carrier of an inkjet printer. By locating the maintenance system within the range over which the inkjet printhead assembly normally moves during full width printing, the printing media carrier may be moved to place the maintenance system in a position proximate the inkjet printhead assembly to be maintained. The printing media carrier may also be moved to place the maintenance system in a position where it may itself be serviced by a docking station.

### BRIEF DESCRIPTION OF DRAWINGS

In drawings which illustrate non-limiting embodiments of the invention:

FIG. 1 shows an inkjet printer according to one embodiment of the invention;

FIG. 2 shows a platen-based inkjet printer according to another embodiment of the invention;

FIG. 3 is a flowchart illustrating a method according to the invention; and,

FIG. 4 is a schematic depiction of one type of service head that may be used in apparatus according to the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

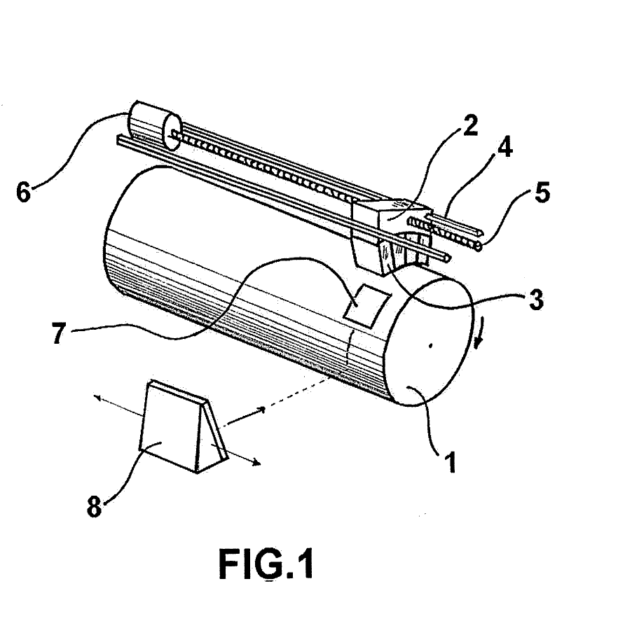

FIG. 1 shows a cylinder based inkjet printer with a partial pagewide inkjet printhead assembly according to one embodiment of the invention. The term inkjet printhead assembly is used herein to describe an inkjet printing head assembly that comprises one or more individual printheads. An inkjet printhead assembly typically has two or more individual printheads. The term individual printhead is used herein to describe an array of inkjet nozzles, typically fashioned as a integrated unit having a common nozzle substrate, and served with ink either from an ink reservoir located within the integrated printhead, or via a hose system from an external ink reservoir.

Many commercial versions of such individual printheads are known and these may be combined by various methods to create an inkjet printhead assembly, some of these being described, for example, in U.S. Pat. No. 5,646,665 and U.S. Pat. No. 5,408,746 and in U.S patent application Ser. No. 09/922,150. To the extent that the various designs for individual printheads are well known in the field, they will not be further described here, nor will the methods of combining them into inkjet printhead assemblies. The term partial pagewide inkjet printhead assembly is used herein to describe an inkjet printhead assembly that may include one or more of arrayed individual printheads, but which does not extend across the entire width of the widest media that the machine is capable of printing on.

Printing media carrier 1, being a cylinder in the case of this first preferred embodiment, is capable of carrying paper or transparencies or other sheet-like printing media. This printing media (not shown) may be of different sizes, textures and compositions. Inkjet printhead assembly 3 is mounted on printhead assembly carriage 2, which moves on linear track 4. Linear track 4 is arranged substantially parallel to the rotational axis of printing media carrier 1 and at such a distance as to allow inkjet printing by printhead assembly 3 on a sheet of printing media. Carriage 2 is translated along the width of printing media carrier 1 by the action of leadscrew 5 and motor 6. A variety of other controlled translation mechanisms are also known in the art, and may alternatively be employed for the purposes of moving carriage 2 in a controlled fashion.

The term inkjet printhead maintenance station is used herein to describe a unit that is used to clean, maintain and/or rejuvenate inkjet nozzles. It may contain, but is not limited to contain, facilities for performing one or more of the following operations:

a) applying vacuum to inkjet nozzles;

b) priming inkjet nozzles, which may be a combination of applying vacuum and allowing a nozzle to spit;

c) capping inkjet nozzles;

d) providing a spittoon into which, or a surface onto which inkjet nozzles may spit;

e) wiping of inkjet nozzles; and,

f) blotting of inkjet nozzles.

Such an inkjet printhead maintenance station is not to be confused with a simple media sheet, which may be simply relocated by means of the media carrier to clean or wipe inkjet nozzles. By way of example, suitable inkjet printhead maintenance facilities that may optionally be included in relocatable inkjet printhead maintenance station 7 are described in U.S. Pat. Nos. 4,855,764, 4,853,717, and 4,746,938 and will not be further detailed here.

Inkjet printhead maintenance station 7 is mounted on printing media carrier 1. In particular, it is located on a portion of printing media carrier 1 which can be reached by inkjet printhead assembly 3 without leaving the range of motion of inkjet printhead assembly 3 which is traversed during normal full-width printing (or without moving inkjet printhead assembly 3 significantly in cases where inkjet printhead assembly 3 is fixed during printing). This portion of printing media carrier 1 is within the “printing area” of printing media carrier 1.

The term printing area is used herein to describe the area defined by the longitudinal section of printing media carrier 1 that can be covered by inkjet printhead assembly 3 during normal full width printing. The printing area may extend substantially around the entire circumference of printing media carrier 1. Inkjet printhead maintenance station 7 is mounted in the printing area of printing media carrier 1. It is to be particularly noted that the printing area of printing media carrier 1 is determined by the physical extent of inkjet printhead assembly 3 and the range over which it travels during printing, and not by the presence or absence of media to print upon. Inkjet printhead maintenance station 7 may be located on a portion of printing media carrier 1 not normally covered by a printing medium during printing.

Inkjet maintenance station 7 may itself have to be serviced from time to time. If and when inkjet maintenance station 7 has to be serviced, printing media carrier 1 is rotated such that inkjet maintenance station 7 is located substantially facing a docking station 8 or positioned such that docking station 8 can be moved to be at least substantially facing maintenance station 7. Docking station 8 services inkjet printhead maintenance station 7. Docking station 8 may be moved closer to printing media carrier 1 in order to be brought into contact with inkjet maintenance station 7, or alternatively, elements of maintenance station 7 may be moved closer to docking station 8. The relative motion of docking station 8 and inkjet printhead maintenance station 7 may be caused by any suitable arrangement of actuators. The term service position is used herein to describe the location of inkjet printhead maintenance station 7 when it is in proximity to docking station 8 so that docking station 8 can service maintenance station 7 or some aspect of maintenance station 7.

To the extent that the various maintenance functions that may be performed by inkjet printhead maintenance station 7 require inkjet printhead maintenance station 7 itself to undergo regular service, docking station 8 is equipped with facilities (not shown) to perform the servicing of inkjet printhead maintenance station 7.

When maintenance of one or more individual printheads is required, printing media carrier 1 is rotated, and carriage 2 is moved by means of leadscrew 5 and motor 6, such that the combined action of the two motions positions inkjet printhead maintenance station 7 in opposition to inkjet printhead assembly 3. This allows such maintenance actions, as may be required at that time, to be performed by inkjet printhead maintenance station 7. Either inkjet printhead maintenance station 7 or inkjet printhead assembly 3 may be moved towards the other by suitable actuators in order to facilitate this function. Printhead maintenance station 7 may be movable between a storage position wherein it does not project substantially past a media-supporting surface of printing media carrier 1 and an operating position wherein it projects past the media-supporting surface toward the inkjet printhead assembly 3. Inkjet printhead assembly 3 does not have to be moved outside the printing area of printing media carrier 1 in order to perform service operations on inkjet printhead assembly 3.

The number of service heads on inkjet printhead maintenance station 7 may be increased such that more than one individual printhead may be serviced simultaneously. The term service head is used herein to describe a unit that comprises an assemblage of one or more facilities required to maintain one individual printhead. Different color individual printheads may require different individual service heads.

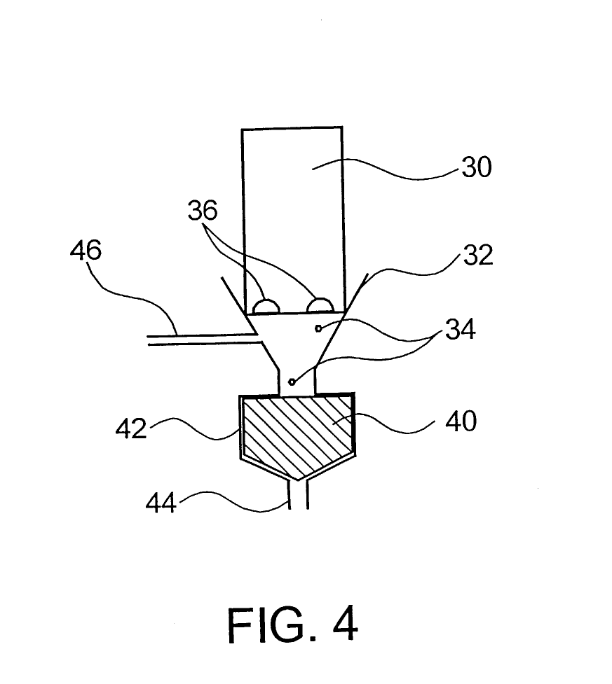

A schematic diagram of a service head is shown in FIG. 4. An individual printhead 30 is in engagement with a funnel like capping arrangement 32. Inkjet fluid droplets 34 are ejected from individual printhead 30 at nozzle orifices 36 and are captured by absorbent material 40. In practice, printhead 30 may have many such nozzles although this is not mandated. In the case where the nozzle is a continuous stream inkjet nozzle there may be only one or very few nozzles on each printhead. A shell 42 surrounds absorbent material 40 and a conduit 44 is connected to the lower end of the shell 42. The conduit 44 is connected to a vacuum source (not shown) that has the function of purging the jetted fluids accumulated in absorbent material 40 from the service head. Alternatively, shell 42 may be omitted and the jetted fluids may be allowed to evaporate from the absorbent material 40. In another alternative cleaning fluid may be introduce into the capping funnel via a conduit 46. The fluid may be required to soften or dissolve hardened inkjet products from nozzles.

The service head in FIG. 4 is shown by way of example only and many variations are possible. Commonly, the service head will be constructed in an array, so that many individual printheads may be serviced simultaneously with many service heads similar to that shown in FIG. 4.

In a specific embodiment of the present invention, inkjet printhead maintenance station 7 comprises an array of service heads that map one-to-one onto the individual printheads of inkjet printhead assembly 3. This allows any number of the individual printheads, up to and including all of them, to be maintained simultaneously, if so required. In a more general embodiment, the array of service heads comprises a plurality of service heads and these service heads are used to service another plurality of individual printheads, without there being a specific numerical relationship between the two pluralities. Some service heads may be redundant and used in case of others failing, while a given service head may service more than one individual printhead.

Docking station 8 may be adapted to maintain more than one service head on inkjet maintenance station 7 at the same time, and, may indeed be so arranged as to maintain all of the service heads on inkjet maintenance station 7 at the same time.

In the embodiment of the invention shown in FIG. 1, inkjet printhead assembly 3 is shown as a partial page width inkjet printhead assembly comprising four individual printheads having only one individual printhead per row substantially parallel to the cylindrical axis of printing media carrier 1. There may be more than one such row, each row comprising one or more individual printheads. These printheads may be, by way of example, four different color individual printheads for the industry-standard Cyan, Magenta, Yellow and Black colors. In a more general embodiment there is no limitation on the number of individual printheads, the combination of printed colors from the individual printheads, or other properties of the individual printheads. For example, individual printheads having different numbers of nozzles or different numbers of nozzles per unit distance may be employed.

In a further embodiment, inkjet printhead assembly 3 has a plurality of individual printheads arranged in rows substantially parallel to the rotational axis of printing media carrier 1, and there may be more than one such row of individual printheads. The individual printheads in adjacent rows may also be staggered in their layout and/or rotated with respect to the rotational axis of the printing media carrier 1. In such an arrangement, inkjet printhead assembly 3, therefore, comprises an array of individual printheads that may extend in one or more directions. In this embodiment there is no limitation on the number of individual printheads, the combination of printed colors from the individual printheads, or other properties of the individual printheads. For example, individual printheads having different number of nozzles or different number of nozzles per unit distance may be employed.

In this embodiment docking station 8 may be adapted to maintain more than one service head on inkjet printhead maintenance station 7 at the same time, and may be so arranged as to maintain all of the service heads on inkjet maintenance station 7 at the same time. In addition, inkjet printhead assembly 3 may comprise an array of individual printheads extending in more than one direction for different colors, and may have a different number of printheads and a different arrangement of printheads for the different colors. This could be done to allow different colors, different combinations of colors, different ink drop sizes, different ink compositions, and/or different resolutions to be printed using fewer individual printheads than if all were to be done with the same number of heads. The arrangement of service heads in inkjet printhead maintenance station 7 may be of any number and type up to and including a complete one-to-one mapping of service heads onto individual printheads. In this embodiment is also evident that docking station 8 may be adapted to maintain more than one service head on inkjet printhead maintenance station 7 at the same time, and, may indeed be so arranged as to maintain all of the service heads on inkjet maintenance station 7 at the same time.

In a further embodiment, the inkjet printhead assembly comprises an array of individual printheads with the array extending across the entire width of printing media carrier 1 in one dimension, and optionally having additional rows of individual printheads arranged at different angular positions around printing media carrier 1. This embodiment of the invention provides a page width printer with multiple rows of individual printheads. In this embodiment the total amount of translation of printhead assembly 3 under the action of leadscrew 5 and motor 6 can be very small, and can therefore, be managed very accurately. Alternatively, the printhead assembly 3 could remain stationary, in which case leadscrew 5 and motor 6 would only be required if print modes requiring translation of the printhead assembly were to be employed. For this reason, implementations wherein such a printhead is translated over long distances for the purposes of maintenance, are not preferred, as this would require, for example, a long and expensive, accurate leadscrew. As with the previous embodiments, service heads in inkjet printhead maintenance station 7 may be of any number and type up to and including a complete one-to-one mapping of service heads onto individual printheads. In this embodiment docking station 8 may be adapted to maintain more than one service head on inkjet printhead maintenance station 7 at the same time, and, may indeed be so arranged as to maintain all of the service heads on inkjet maintenance station 7 at the same time.

This embodiment of the invention allows docking station 8 to be maintained at a fixed position. With an inkjet printhead maintenance station 7 that can have a one-to-one mapping of service heads onto individual printheads, the only translation required is within the normal range of printing movement of inkjet printhead assembly 3. This significantly reduces the complexity of the maintenance system for the pagewide printer.

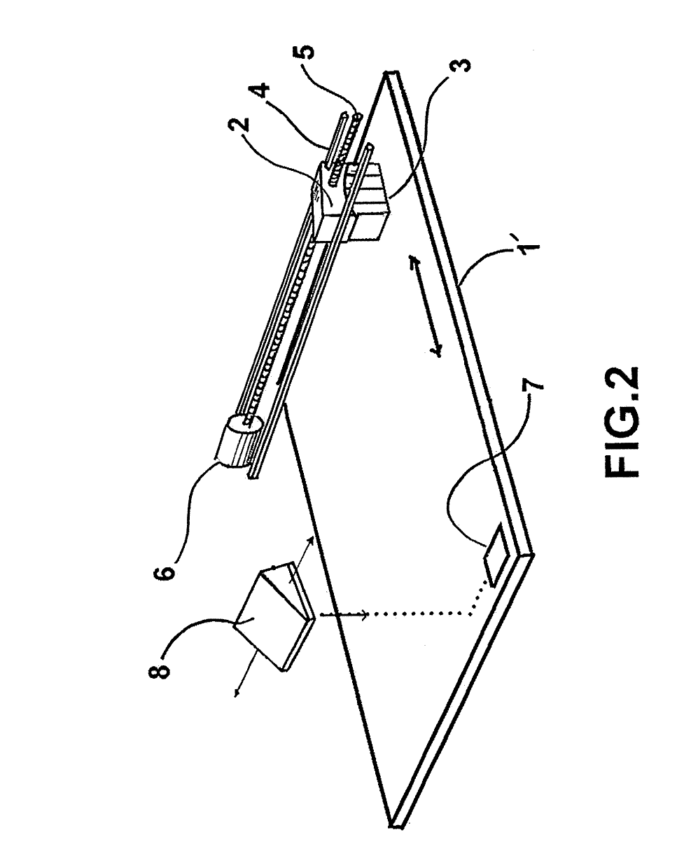

In a further embodiment of the invention, as shown, for example in FIG. 2, printing media carrier 2 comprises a platen 1′ in a flatbed printer arrangement. The term platen is used herein to describe a flat plate that is movable in at least one dimension within its plane, or on which media to be printed on is moved in at least one dimension within its plane. This is shown in FIG. 2. All the aspects of the invention work in the same way as with the cylinder-based implementation, with the exception that platen 1′ is not rotated, but rather, translated, to position inkjet printhead maintenance station 7 proximate inkjet printhead assembly 3. In this embodiment, the printing area of the media carrier is again defined, in a first dimension, by the longitudinal section of platen 1′ that can be traversed by inkjet printhead assembly 3 during normal full width printing, and, in a second perpendicular dimension, by the full range of relative motion of the inkjet printhead assembly with respect to platen 1′. The printer area is typically substantially rectangular.

A further embodiment of the invention comprises platen printers in which all the relative motion between platen and inkjet printhead assembly is performed by moving the inkjet printhead assembly in two dimensions while the platen remains fixed and stationary. In such implementations, the inkjet printhead maintenance station is also located within the printing area. The printing area is as defined for the previous embodiment of the present invention, except that both dimensions of the printing area are defined by the range of motion of the inkjet printhead assembly.

In yet further embodiments, other types of printing media carrier may be employed, including, but not limited to, platens that have shapes other than a flat plate. An example is a platen of which the curvature is substantially a segment of a circle. Such arrangements are particularly useful by virtue of the fact they are easier to translate, employing rotary means without the need for cumbersome mechanical arrangements.

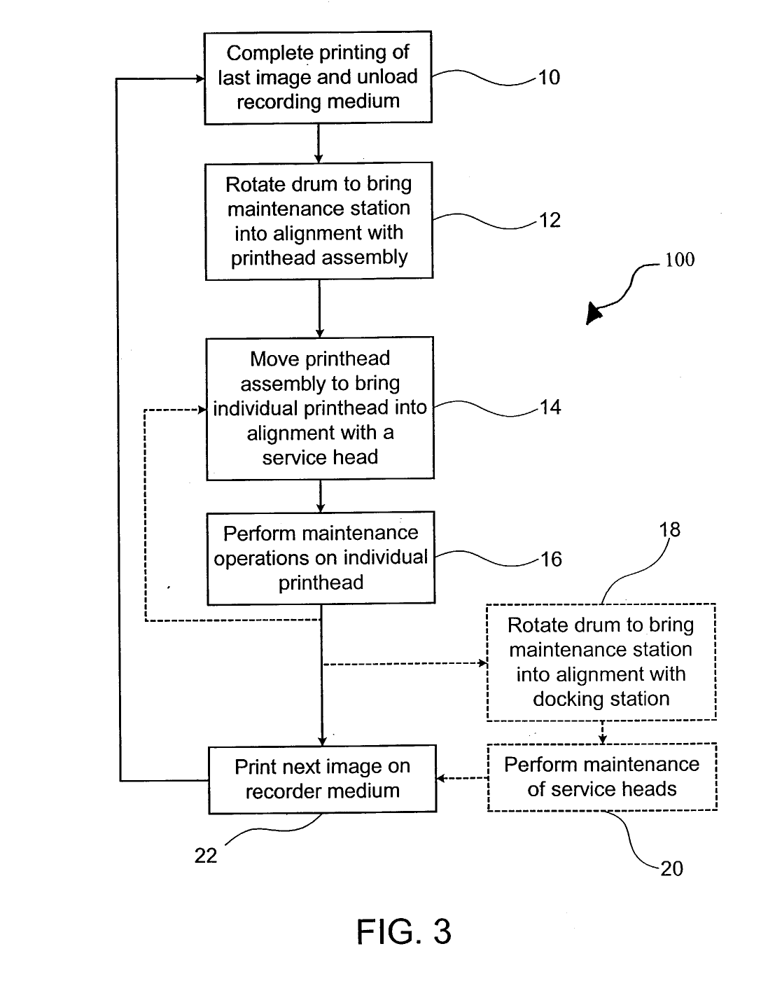

A method 100 of the invention is shown in the form of a process flowchart in FIG. 3. In step 10, on completion of the printing of the last image on a recording medium, the recording medium is unloaded from the printing media carrier. Where the printing media carrier is a drum, the drum is rotated to bring the maintenance station into alignment with the printhead assembly in step 12. Steps 14 and 16 will vary depending on the configuration of the printhead and the maintenance station. If there are fewer service heads than individual printheads the printhead assembly will typically move a particular subset of assemblies into alignment with the corresponding service heads in step 14 and then perform the maintenance operations in step 16. Steps 14 and 16 would then be repeated until all individual printhead have been serviced (or if desired, some subset of the individual printheads).

Where there is a one-to-one correspondence between individual printheads and service heads, step 14 is unnecessary, and the maintenance operations may commence directly at step 16. Steps 18 and 20 optionally allow the maintenance station to be aligned with a docking station to allow maintenance of the service heads in the maintenance station. These steps may include cleaning of service heads, unclogging or evacuation of accumulated inkjet fluids. Steps 18 and 20 may be performed after a specified number of maintenance operations have been performed in steps 14 and 16.

The operation of apparatus according to this invention may be coordinated by any suitable controller. The controller may, for example, comprise a computer processor executing software instructions or a hard-wired controller. The controller operates actuators such as motor 6, a drive motor for drum 1, linear actuators, or the like connected to move platen 1′ and other components of the apparatus into desired relative positions. The design of suitable controllers and actuators is well known in the art.

Preferred embodiments of the invention make optimal use of the translation assemblies that are fundamentally required for the printing process and thereby necessarily present. Printers according to the invention may be compact. Extra space is not required beyond the drive assemblies for the print media carrier and the leadscrews. This is a result of the fact that, for purposes of maintenance, the printhead assembly carriage 2 never has to be translated outside the limits within which it normally moves during full width printing (if it moves during full-width printing). Use of the invention reduces the demands on the highly accurate and very busy precision drives of the printhead assembly and thereby reduces the wear and tear on such precision drives. Preferred embodiments of the invention may use comparatively short precision drives, such as the leadscrew arrangement of the first embodiment, making such embodiments lower cost and easier to manufacture to the appropriate precision.

There has thus been outlined the important features of the invention in order that it may be better understood, and in order that the present contribution to the art may be better appreciated. Those skilled in the art will appreciate that the conception on which this disclosure is based may readily be utilized as a basis for the design of other apparatus and methods for carrying out the several purposes of the invention. It is most important, therefore, that this disclosure be regarded as including such equivalent apparatus and methods as do not depart from the spirit and scope of the invention.

What is claimed is:

1. A method for maintaining one or more individual printheads in an inkjet printer, the method comprising:
aligning a printhead maintenance station, located in a printing media carrier, with the one or more printheads; and,
performing maintenance operations on the one or more individual printheads.

2. The method of claim 1 wherein aligning the printhead maintenance station with the one or more printheads comprises moving:
the inkjet printhead assembly; or
the printing media carrier; or
both the inkjet printhead assembly and the printing media carrier.

3. The method of claim 2 comprising, moving the printhead maintenance station from a position wherein it does not project past a printing media-supporting surface of the printing media carrier to a position wherein the printhead maintenance station projects past the printing media-supporting surface toward the inkjet printhead assembly.

4. The method of claim 1 comprising periodically aligning the inkjet printhead maintenance station in a service position with a docking station and maintaining one or more service heads of the inkjet printhead maintenance station.

5. The method of claim 4 aligning the inkjet printhead maintenance station with docking station comprises moving:
the printing media carrier; or
the docking station; or
both the printing media carrier and the docking station.

6. An inkjet printing apparatus comprising:
an inkjet printhead assembly having one or more inkjet printheads;
a printing media carrier; and,
a printhead maintenance station located within a printing area of the printing media carrier.

7. The apparatus of claim 6 wherein the printing media carrier comprises a rotatable cylindrical drum and the apparatus comprises a controller configured to bring the one or more inkjet printheads into alignment with the printhead maintenance station by:
rotating the cylindrical drum; or
moving the printhead assembly; or
both rotating the cylindrical drum and moving the printhead assembly.

8. The apparatus of claim 6 comprising a controller wherein the printing media carrier comprises a flatbed platen and the controller is configured to operate one or more actuators to align the one or more inkjet printheads with the printhead maintenance station by moving:
the inkjet printhead assembly; or
the printing media carrier; or
both the inkjet printhead assembly and the printing media carrier.

9. The apparatus of claim 6 wherein the inkjet printhead assembly comprises first a plurality of individual inkjet heads and the printhead maintenance station comprises second a plurality of service heads, the second plurality being equal to or smaller than the first plurality.

10. The apparatus of claim 6 comprising a docking station for performing maintenance on the service heads of the printhead maintenance station.

11. The apparatus of claim 10 comprising a controller configured to control one or more actuators to bring the docking station into the service position by moving:
the docking station; or
the printing media carrier; or
both the docking station and the printing media carrier.

12. The apparatus of claim 6 wherein the inkjet printhead assembly is movable toward and away from the printing media carrier and the apparatus comprises an actuator coupled to the inkjet printhead assembly, the actuator operable to move the printhead assembly toward the printhead maintenance station.

13. The apparatus of claim 6 wherein the printhead maintenance station is movable toward and away from the inkjet printhead and the apparatus comprises an actuator operative to move the printhead maintenance station toward the inkjet printhead.
